(19) United States
(12) Patent Application Publication
(10) Pub. No.: US 2025/0363441 A1
(43) Pub. Date: Nov. 27, 2025

(54) GENERATING CONSOLIDATED GRAPHICAL USER INTERFACES FOR DISPLAYING DIRECTIVES OF DEVICES OF A DYNAMIC TRANSPORTATION NETWORK

(71) Applicant: Lyft, Inc., San Francisco, CA (US)

(72) Inventors: Trevor Lewis Pels, San Francisco, CA (US); Hong Guo, San Francisco, CA (US); Yudi Sun, San Francisco, CA (US); Timothy Ryan Woo, San Francisco, CA (US)

(21) Appl. No.: 19/286,616

(22) Filed: Jul. 31, 2025

Related U.S. Application Data
(63) Continuation of application No. 16/580,218, filed on Sep. 24, 2019.
(60) Provisional application No. 62/856,709, filed on Jun. 3, 2019.

(51) Int. Cl. G06Q 10/0639; G01C 21/34; G06Q 10/0631; G06Q 30/0282; G06Q 50/40; G08G 1/00; H04L 67/12

(52) U.S. Cl. CPC G06Q 10/06395; G01C 21/3438; G06Q 10/06315; G06Q 30/0282; G06Q 50/40; G08G 1/202; H04L 67/12

(57) ABSTRACT

The disclosed computer-implemented method may include collecting performance data associated with performance of a transportation provider within a dynamic transportation network. The method may also include simultaneously displaying a status summary message on a transportation provider device that reflects the performance data and a notification message. The notification message may coach the transportation provider to improve a transportation service in light of the performance data. Other methods, systems, and computer-readable media are disclosed.

### CROSS REFERENCE TO RELATED APPLICATION

This application is a continuation of U.S. patent application Ser. No. 16/580,218, filed on Sep. 24, 2019, which claims the benefit of and priority to U.S. Provisional Patent Application No. 62/856,709, filed on Jun. 3, 2019. Each of the aforementioned applications is hereby incorporated by reference in its entirety.

### BRIEF DESCRIPTION OF THE DRAWINGS

The accompanying drawings illustrate a number of exemplary embodiments and are a part of the specification. Together with the following description, these drawings demonstrate and explain various principles of the instant disclosure.

FIG. 1 is an illustration of a transportation provider and a transportation requester in a transportation management system.

FIG. 2 is a block diagram of an example system for providing consolidated feedback messages to a transportation provider.

FIG. 3 illustrates an example device screen for providing consolidated feedback messages to a transportation provider.

FIG. 4 illustrates another example device screen for providing consolidated feedback messages to a transportation provider.

FIG. 5 illustrates an example device screen for providing consolidated feedback messages to coach a transportation provider in improving performance.

FIG. 6 illustrates an example device screen for providing compliment and milestone messages to a transportation provider.

FIG. 7 illustrates an example device screen for providing consolidated feedback messages to a new transportation provider.

FIG. 8 illustrates an example device screen for confirming transportation services by a transportation provider.

FIG. 9 is a flow diagram of an example method for consolidating feedback to transportation providers in transportation management systems.

FIG. 10 is an illustration of an example transportation requester/transportation provider management environment.

FIG. 11 is an illustration of an example data collection and application management system.

Throughout the drawings, identical reference characters and descriptions indicate similar, but not necessarily identical, elements. While the exemplary embodiments described herein are susceptible to various modifications and alternative forms, specific embodiments have been shown by way of example in the drawings and will be described in detail herein. However, the exemplary embodiments described herein are not intended to be limited to the particular forms disclosed. Rather, the instant disclosure covers all modifications, equivalents, and alternatives falling within the scope of the appended claims.

### DETAILED DESCRIPTION OF EXEMPLARY EMBODIMENTS

The present disclosure is generally directed to providing consolidated feedback to transportation providers in the context of providing transportation services in a dynamic transportation network. The feedback provided to transportation providers may be provided in the context of certain actions, requirements, or services performed by the transportation provider. The feedback may be provided to the transportation provider in the form of messages delivered to a computing device of the transportation provider. The feedback may be determined based on performance data that is associated with transportation services provided by the transportation provider and may be collected from multiple sources. Methods of the present disclosure may include monitoring contextual data that describes a context within which the transportation provider is providing the transportation service and determining, based at least in part on the contextual data, that the performance data is relevant to the context. The methods may also include providing a feedback message to a transportation provider device for coaching the transportation provider to improve the transportation service.

As will be explained in greater detail below, providing consolidated feedback to coach transportation providers to improve transportation service performance using the systems methods disclosed herein may provide benefits to the operation of a transportation management system. Accordingly, as may be appreciated, the systems and methods described herein may improve the functioning of a computer that implements transportation matching. For example, these systems and methods may improve the functioning of the computer by improving transportation routing decisions and the efficiency of the dynamic transportation system. Additionally or alternatively, these systems and methods may improve the functioning of the computer by reducing the computing resources consumed to provide consolidated feedback messages to transportation providers (e.g., thereby freeing computing resources for other tasks, such as those directly and/or indirectly involved in transportation matching). Examples of transportation providers may include drivers, automated vehicle operators, or automated vehicle attendants. Drivers may include humans operating transportation provider vehicles.

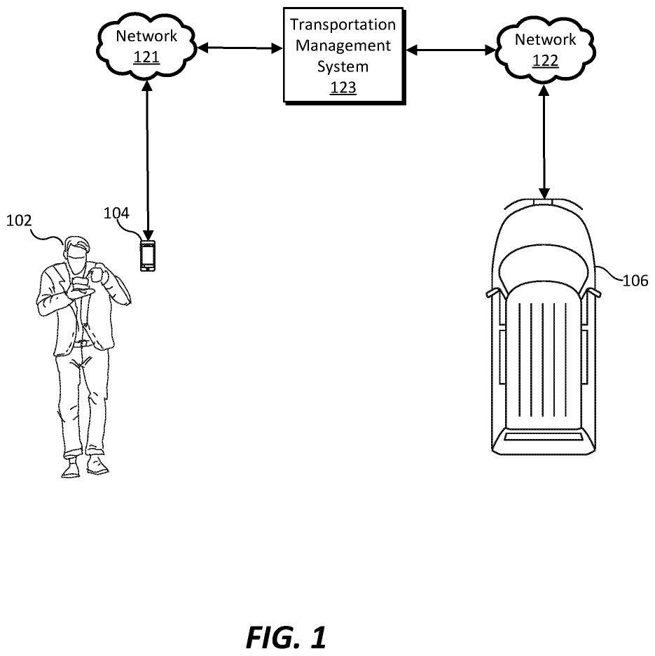

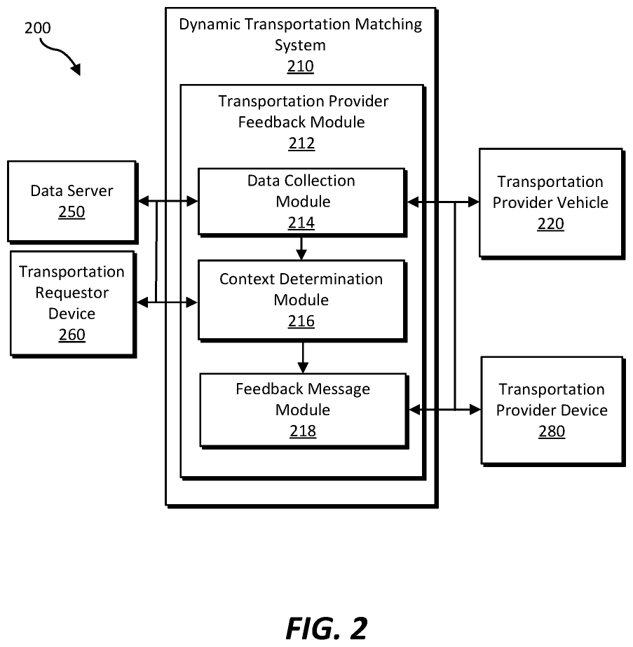

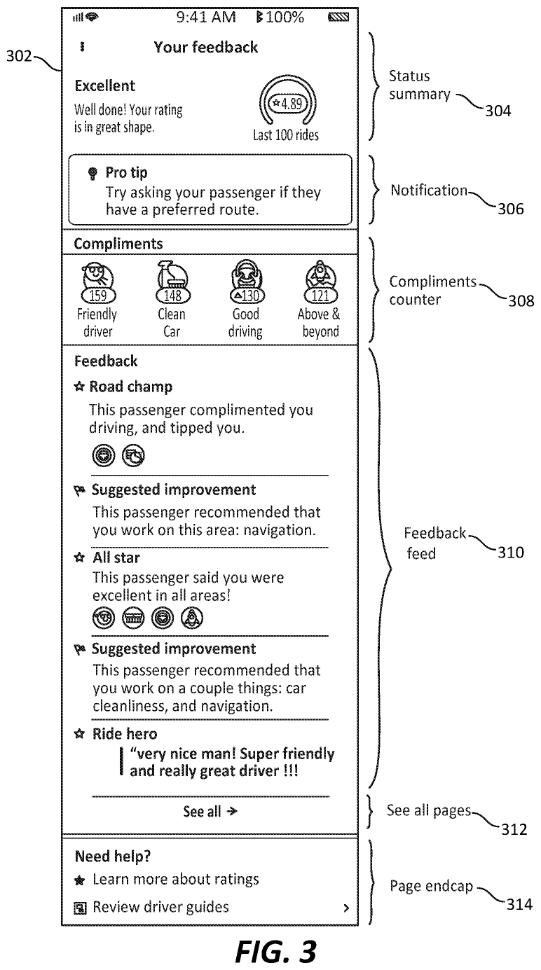

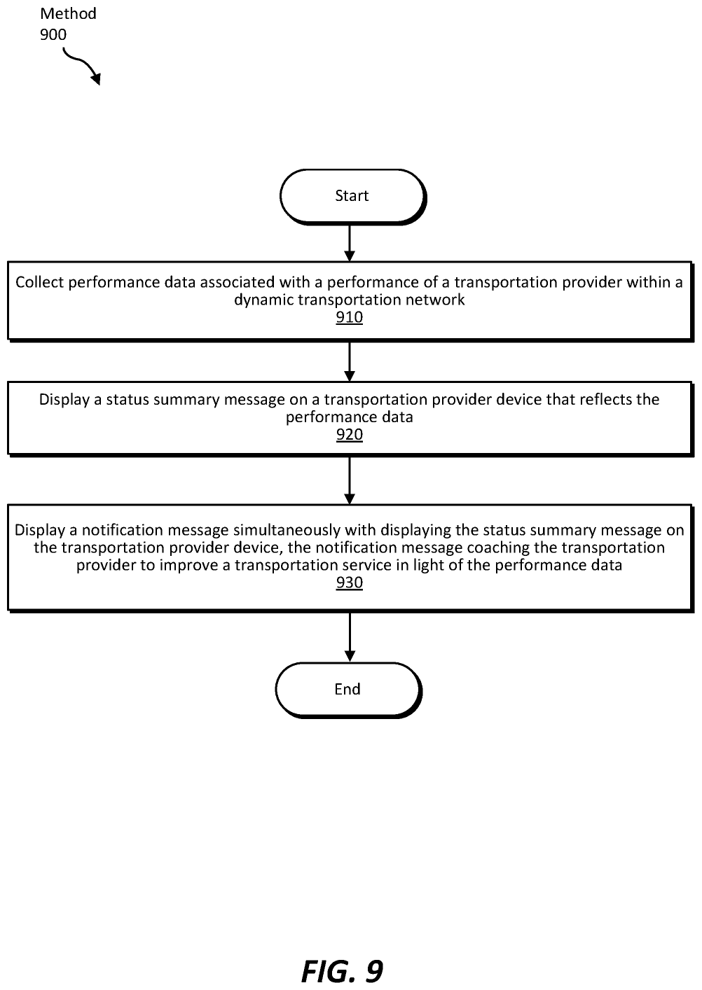

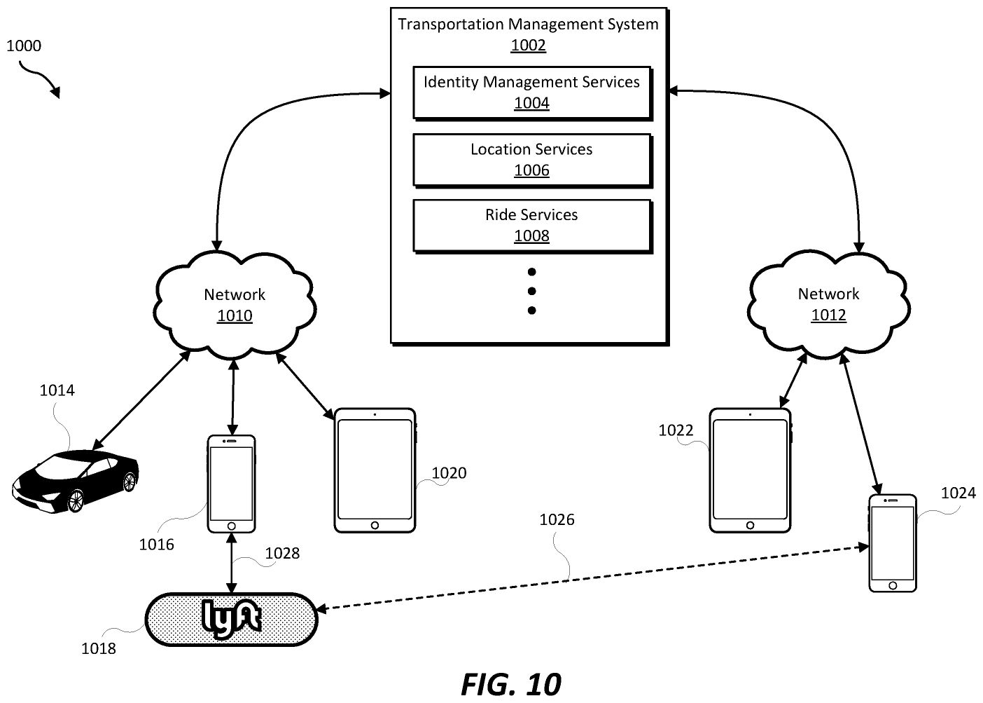

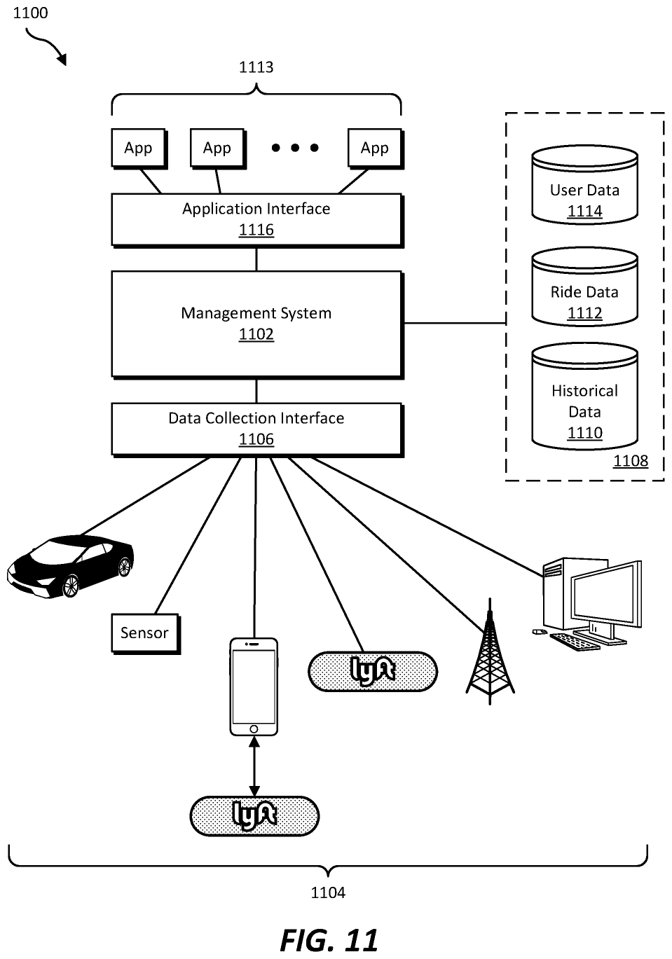

The following will provide, with reference to FIG. 1, detailed descriptions of a transportation requester requesting transportation services and a transportation provider providing transportation services. Descriptions of FIG. 2 will provide details of a dynamic transportation system providing consolidated feedback messages to transportation providers within a context of transportation services. Descriptions of FIGS. 3-8 will provide details of methods of providing the consolidated feedback message, methods of collecting performance data, and methods of monitoring contextual data that describes a context within which the transportation provider is providing a transportation service. Descriptions of FIG. 9 will provide details of a method for providing consolidated feedback messages to a transportation provider. Descriptions of FIGS. 10 and 11 will provide details of an example transportation requester/transportation provider management environment.

FIG. 1 is an illustration of a transportation provider and a transportation requester in a transportation management system. As shown in FIG. 1, a transportation management system may include transportation requester 102 requesting transportation services. Transportation services may be provided by a transportation provider operating transportation provider vehicle 106. Transportation requester 102 may request a transportation service using computing device 104 (e.g., a smartphone). Computing device 104 may provide the request for transportation service to transportation management system 123 through network 121. A transportation provider operating transportation provider vehicle 106 may provide transportation services to transportation requester 102. The transportation provider may operate computing device 104 (e.g., a smartphone) that sends and receives information associated with requests and matches for transportation service from transportation management system 123 through network 122. Although FIG. 1 shows network 121 and network 122 as different networks, the present disclosure is not limited to such. Network 121 and network 122 may be the same network or may be different networks.

A dynamic transportation network may seek to improve the quality of transportation services provided by the transportation provider to transportation requester 102 and other transportation requesters. The dynamic transportation network may improve the quality of transportation services by providing feedback messages to the transportation provider that coach the transportation provider to improve transportation services. In some examples, the dynamic transportation network may collect performance data from a variety of sources that is associated with the performance of the transportation provider. The dynamic transportation network may also monitor the context within which the transportation provider is providing the transportation service and determine that the performance data is relevant to the context. The collection and monitoring of data (including, e.g., performance data and data describing the context) may be disabled based on transportation provider and/or transportation requester preferences. Collected data may be periodically erased (e.g., hourly or daily). The dynamic transportation network may provide the feedback messages to a transportation provider device in response to determining that the performance data is relevant to the context in order to coach the transportation provider to improve transportation services.

FIG. 2 is a block diagram of an example system for providing consolidated feedback messages to a transportation provider. As shown in FIG. 2, system 200 may include dynamic transportation management system 210, which may be configured with transportation provider feedback module 212. In one example, transportation provider feedback module 212 may include feedback collection module 214, context determination module 216, and feedback message module 218. Transportation provider feedback module 212 may provide consolidated feedback messages to a transportation provider using any suitable method. Transportation provider feedback module 212 may collect performance data associated with the performance of the transportation provider within the dynamic transportation network, monitor contextual data that describes the context within which the transportation provider is providing a transportation service, and determine, based on the contextual data, that the performance data is relevant to the context. In response to determining that the performance data is relevant to the context, transportation provider feedback module 212 may provide the feedback message to a transportation provider device (e.g., a smartphone) to coach the transportation provider to improve transportation services in light of the performance data.

Data that is relevant to a transportation provider's performance may be collected using any suitable method. In some examples, data collection module 214 may receive data relevant to a transportation provider's performance from transportation requester 102 that has received and/or is receiving transportation service from the transportation provider. Data collection module 214 may receive data relevant to a transportation provider's performance from transportation requester computing device 260 (e.g., computing device 104). The data collected from transportation requester computing device 260 may include performance data. Performance data may include data associated with, without limitation, the timeliness of the transportation service, the accuracy of a pickup location, the accuracy of a drop-off location, the transportation provider's compliance to the transportation requester's preferences, the cleanliness of the transportation provider's vehicle, the demeanor of the transportation provider, the driving skills of the transportation provider, the customer service provided by the transportation provider, or a combination thereof. The collection of performance data may be disabled based on transportation provider and/or transportation requester preferences. Collected data may be periodically erased (e.g., hourly or daily).

The data collected from transportation requester 102 may also include sensor data from transportation provider vehicle 220 (e.g., vehicle 106). The sensor data collected from transportation provider vehicle 220 may include, without limitation, door closing event data, a location of transportation provider vehicle 220 relative to a transportation service travel route, a pickup location, a drop-off location, a maintenance status of the vehicle, a speed of the vehicle, a linear acceleration of the vehicle, a rotational acceleration of the vehicle, a braking profile of the vehicle, a condition of the vehicle, or a combination thereof.

The data collected from transportation requester 102 may also include data from data server 250. Data collected from data server 250 may include data associated with operation of transportation provider vehicle 220 and/or performance of the transportation provider. Data collected from data server 250 may include, without limitation, a status of vehicle insurance, a transportation provider rating, an account standing score, a type of vehicle, or a combination thereof.

In some examples, context determination module 216 may monitor contextual data that describes a context within which the transportation provider is providing the transportation service. Contextual data that describes a context within which the transportation provider is providing a transportation service may be monitored using any suitable method. For example, contextual data may be monitored by examining data received from a transportation management system application running on a transportation provider's device and/or received from a transportation management system application running on a transportation requester's device. A transportation requester may enter contextual data on the transportation management system application including, without limitation, a type of requested transportation service, transportation requester preferences associated with the transportation service, a requested pickup location, a number of passengers, a requested drop-off location, or a combination thereof. As another example of contextual data, a transportation provider may enter contextual data on the transportation management system application indicating an actual pickup location, an actual drop-off location, or a combination thereof. Data monitoring may be disabled based on transportation provider and/or transportation requester preferences. Contextual data may be periodically erased (e.g., hourly or daily).

In some examples, context determination module 216 may monitor and/or determine contextual data including, without limitation, a type of transportation service, a pickup location of the transportation service, a drop-off location of the transportation service, a transportation service history of the transportation provider, a preference of the transportation requester, or a combination thereof.

Feedback message module 218 may provide consolidated feedback messages to transportation provider device 280 (e.g., a smartphone) to coach the transportation provider to improve the transportation service in light of the performance data and the context within which the transportation service is provided. Feedback message module 218 may provide feedback messages to transportation provider device 280 using any suitable method. Feedback message module 218 may provide feedback messages to transportation provider device 280 over network 122 by displaying an ordered and/or prioritized list of feedback messages. For example, feedback message module 218 may provide data included in a feedback home screen that provides a consolidated method in a transportation matching system application for transportation providers to access all information related to their performance and account status.

FIG. 3 illustrates an example device screen for providing consolidated feedback messages to a transportation provider. Referring to FIG. 3, device screen 302 (e.g., feedback home screen) may include consolidated feedback messages to improve the transportation provider's performance based on the collected performance data and the context within which the transportation provider is providing the transportation service. Device screen 302 may display the consolidated feedback messages using any method and/or any format. For example, device screen 302 may include a high level status summary message 304 of the transportation provider's performance at the top of the screen. Status summary message 304 may include the transportation provider's rating (e.g., rating of 4.89) over a number of previous transportation services completed (e.g., over the previous 100 transportation services). In some examples, the transportation provider's rating may be determined based on an average of ratings for the transportation provider received from transportation requesters on a scale of O to 5. The transportation providers may be placed in a tier based upon the transportation provider's rating. For example, a rating greater than 4.8 may place the transportation provider in the highest tier (e.g., excellent performance), a rating less than 4.8 and higher than 4.6 may place the transportation provider in the next highest tier (e.g., good performance), and a rating less than 4.6 may place the transportation provider in a lower tier (e.g., less than acceptable performance).

In some examples, the transportation providers may be placed in a tier based upon the transportation provider's account standing score. A transportation provider may be assigned an account standing score based on the transportation provider's conformance to transportation service requirements of the transportation management system, whereas the transportation provider rating may be based on ratings received from transportation requesters. The account standing score may be an accumulation of points over a period chime (e.g., a week, a month, etc.) and/or over a set number of transportation services completed. The transportation provider may receive a number of points for each occurrence of an event that is non-compliant to transportation service requirements. The number of points may be dependent on the level of non-compliance. The transportation providers may be placed in a tier based upon the number of points accumulated over a time period. For example, an account standing score less than a first threshold (e.g., less than 13) may place the transportation provider in the highest tier (e.g., excellent performance), an account standing score within a range higher than the first threshold and lower than a second threshold (e.g., higher than 13 and less than 18) may place the transportation provider in the next highest tier, an account standing score within a range higher than the second threshold and lower than a third threshold (e.g., higher than 19 and less than 36) may place the transportation provider in the next highest tier, and an account standing score higher than the third threshold (e.g., higher than 36) may place the transportation provider in the lowest tier (e.g., less than acceptable performance). In some examples, a combination of transportation provider ratings and account standing scores may be used to determine a transportation providers performance. The combination of transportation provider ratings and account standing scores may be used to place the transportation provider in a category of performance (e.g., excellent, good, at risk of deactivation, at risk of suspension, final warning for deactivation). A transportation provider may transition from one tier to another as their rating and/or account standing score changes over time based on their performance and the collected feedback.

In some examples, a transportation provider may be deactivated due to a status of their rating and/or account standing score. Transportation providers may view the feedback home screen for details as to the reason for the deactivation and the context within which the deactivation occurred. Within the feedback home screen transportation requesters may be referred to an alternate method of receiving feedback (e.g., email) to view the reasons for deactivation. Transportation providers may be referred to the alternate method of receiving feedback when the reasons for deactivation are sensitive (e.g., safety related) or complicated to explain (e.g., compliance to service requirements). Transportation providers may be temporarily deactivated and receive notifications that override other feedback messages such as guided improvements.

Status summary message 304 may also include a feedback message (e.g., “Excellent, Well done! Your rating is in great shape”) that is consistent in content with the transportation provider's rating. Notification message 306 may be displayed simultaneously with status summary message 304 and may include a tip (e.g., “Try asking your passenger if they have a preferred route”) that coaches the transportation provider in improving their performance. The consolidated feedback messages may be displayed on a screen of the transportation provider's device such that the status summary and higher priority messages (e.g., safety related messages) may appear on the top of the screen and the transportation provider may scroll down to view the feedback messages below. In some examples, the tips provided in notification message 306 may motivate the transportation provider to implement the advice provided in the tip to improve their performance.

Compliments counter 308 may include compliments received from transportation requesters that have previously been provided transportation services by the transportation provider in a context within which the transportation provider provided the transportation service. Compliments counter 308 may include icons associated with different compliments. For example, compliments counter 308 may include an icon indicating a friendly driver compliment and a count (e.g., 159) of the number of friendly driver compliments the transportation provider has received. As another example, compliments counter 308 may include an icon indicating a clean car compliment and a count (e.g., 148) of the number of clean car compliments the transportation provider has received. As another example, compliments counter 308 may include an icon indicating a good driving compliment and a count (e.g., 130) of the number of good driving compliments the transportation provider has received. As another example, compliments counter 308 may include an icon indicating a service above and beyond compliment and a count (e.g., 121) of the number of service above and beyond compliments the transportation provider has received. In some examples, the compliments counter 308 may be presented in a manner that motivates the transportation provider to improve their performance and thereby increase the number of compliments received.

Feedback feed 310 may include feedback and/or comments received from transportation requesters that have previously been provided transportation services by the transportation provider in a context within which the transportation provider provided the transportation service. Feedback feed 310 may include icons representing the context of the feedback. Feedback feed 310 may include compliments received from transportation requesters (e.g., Road champ), suggested improvements for transportation provider performance (e.g., work on navigation), and direct quotes from the transportation requester (e.g., very nice man! Super friendly and really great driver!!!). Feedback messages from transportation requesters may be anonymized such that the transportation requester is unable to identify the transportation requester that provided the feedback. Further, feedback feed 310 may provide the feedback messages in a randomized order and batch format so that the feedback messages are provided as a group. As an example of a batch format, the feedback messages may be displayed in a group such that the transportation provider may view the feedback messages together. The batch format may be viewed as a list of feedback messages grouped together on the display screen of the transportation provider computing device. Feedback feed 310 may provide the feedback messages to the transportation provider at any time including before a transportation shift begins, during a transportation shift while the vehicle is stationary, after a transportation shift is completed, or a combination thereof. In some examples, the feedback feed 310 may provide feedback to the transportation provider as to how they can improve their performance and motivate the transportation provider to improve their performance.

Feedback feed 310 may provide feedback message in the context of a transportation provider's rating. For example, if a transportation provider's rating is less than acceptable (e.g., less than a threshold, for example, less than 4.6) feedback feed 310 may display all feedback as guided improvements. If a transportation provider's rating is good (e.g., greater than 4.6 and less than 4.8) feedback feed 310 may display feedback the transportation requester has received a set number of times (e.g., twice) within a recent number of transportation services (e.g., last 100 transportation services). If a transportation provider's rating is excellent (e.g., greater than a threshold, for example, greater than 4.8) feedback feed 310 may display only feedback which the transportation provider has received at least a set number of times over a set number of transportation services (e.g., three times within the last 100 transportation services) or only the feedback the transportation provider has received at least a set number of times (e.g., at least twice) as tips.

In some examples, additional pages of feedback may be available to the transportation provider. For example, see all pages 312 section of device screen 302 may include a prompt (e.g., “See all”) that the transportation provider may select in order to load additional feedback messages. Page endcap 314 section of device screen 302 may include a prompt (e.g., “Learn more about ratings”, “Review driver guides”) that the transportation provider may select in order to load additional pages that include information on how the transportation provider may improve their performance.

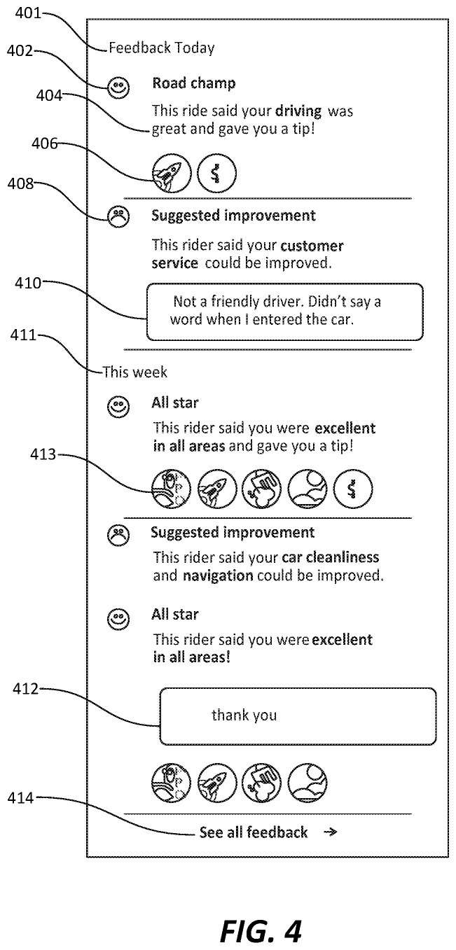

FIG. 4 illustrates another example device screen for providing consolidated feedback messages to a transportation provider. The feedback messages shown in the device screen of FIG. 4 may be based on performance data requested from a transportation requester in a context within which the transportation provider is providing transportation services. The performance data may be requested from transportation requesters in the form of a binary interactive element (e.g., dynamic feedback flag) selected by the transportation requester within a context of a recent transportation service provided by the transportation provider. The binary interactive element may include at least one icon displayed on a device screen of transportation requester device 260 (e.g., a smartphone) running a dynamic transportation system application. For example, the binary interactive element may include an icon similar to those shown in compliments 602. The binary interactive element may include an icon that graphically represents performance feedback associated with a recent transportation service provided by the transportation provider. For example, the binary interactive element may include, without limitation, an icon representing a friendly driver, an icon representing a clean car, an icon representing good driving, an icon representing service above and beyond, or a combination thereof. The transportation requester may activate any binary interactive element (e.g., touching the icon on a touchscreen of transportation requester device 260) which may be transmitted to data collection module 214. The consolidated feedback screen may display a default number (e.g., five) of feedback items. The consolidated feedback screen may display a default number (e.g., two) section headers. The section headers may indicate a time period in which the feedback was generated. For example, section header 401 may display a time period of the present day, the present week, or no time period, in order to ensure that at least two ratings are displayed. Section header 411 header may display feedback generated during the present week, the previous week, or another time period to cover the remaining feedback items. The consolidated feedback screen may display icons representing the sentiment of the feedback. For example, icon 402 may represent positive performance feedback. Feedback text may be associated with icon 404 and include details of the feedback and/or context of the feedback. Icons 406 may represent feedback that was requested from transportation requesters based on the context of a recent transportation service provided by the transportation provider. The context may be based on characteristics of the transportation service including, without limitation, a pickup/drop-off location (e.g., airport, home, shopping mall, hotel, etc.), a length of service of the transportation provider (e.g., new transportation provider), a type of transportation provider vehicle (e.g., a luxury vehicle), or a combination thereof. As another example, icon 408 may represent negative feedback and a suggested improvement may be displayed to coach the transportation provider to improve their performance. Direct quote 410 may provide a direct quotation comment from a transportation requester regarding the transportation provider's performance and include the context in which the feedback is provided. Positive feedback may be accompanied by badges 413 and text 412. Each of badges 413 may represent a type of compliment and text 412 may be displayed with compliment badges 413 indicating the context within which the compliments are provided. An additional badge and text may be displayed when a transportation provider receives a compensation tip from the transportation requester. Negative feedback may be displayed as text only without icons or badges.

In some examples, the balance of feedback items may be viewed by selecting the see-all-feedback icon 414. Selecting the see-all feedback icon 414 may load additional screen pages of feedback messages and icons. The additional screen pages of feedback messages and icons may appear in the same format as the feedback appearing under section headers 401 and 411. The additional screen pages of feedback messages may provide the most recent feedback (e.g., the last 100 transportation services provided) in a similar format to the feedback home screen. For example, the additional screen pages of feedback messages may display messages received from transportation requesters. The additional screen pages of feedback messages may be displayed within sections designating a time frame (e.g., today, this week, this month, earlier) and be displayed in descending chronological order. See-all-feedback icon 414 may appear when a transportation provider has more than a threshold number (e.g., five) of feedback messages.

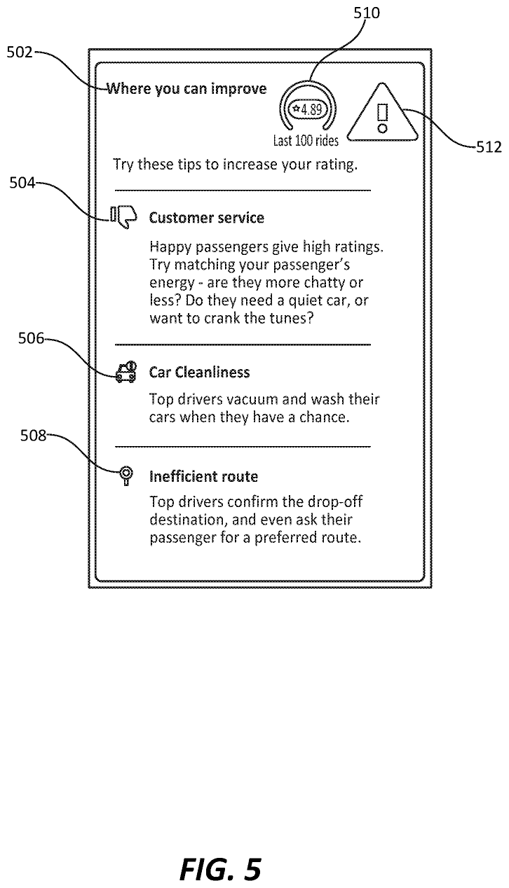

FIG. 5 illustrates an example device screen for providing consolidated feedback messages to coach a transportation provider in improving performance. FIG. 5 illustrates a device screen for providing specific tips to the transportation provider to coach the transportation provider on how they may improve their performance, account standing score, rating, or a combination thereof. The tips may be provided based on the collected performance data and the context within which the transportation provider is providing the transportation service. For example, heading 502 may display a general feedback message related to improvement of transportation provider rating and/or account standing score. Section 504 may display tips for coaching a transportation provider on how to improve customer service (e.g., matching a transportation requester's energy or observing their preferences). Section 506 may display tips for coaching a transportation provider on how to improve their vehicle's cleanliness. Section 508 may display tips for coaching a transportation provider on how to improve their driving ability (e.g., requesting a transportation requester's preferred travel route, reminding the transportation provider to secure their computing device while driving). In some examples, the dynamic transportation system application running on the computing device may provide consolidated feedback messages and tips for coaching the transportation provider on how to improve their performance and/or driving ability in real time. The dynamic transportation system application may act as a virtual coach and provide coaching tips as the transportation providers are providing the transportation service to transportation requesters. For example, the dynamic transportation system application may provide a coaching tip to open and/or unlock a door of the vehicle as the vehicle arrives at a pickup or drop-off location. As another example, the dynamic transportation system application may provide a coaching tip to load or unload a transportation requester's luggage as the vehicle arrives at a pickup or drop-off location. As another example, the dynamic transportation system application may provide a coaching tip to ask the transportation requester if they have a preferred travel route when the transportation requester enters the vehicle.

In some examples, the dynamic transportation system application running on the computing device may provide consolidated feedback messages in the form of icons. Icon 510 may display a gauge icon and the current rating number of the transportation provider. Icon 512 may display a hazard icon indicating the transportation provider is at risk of suspension or deactivation. In some examples, both icon 510 and icon 512 may be displayed, icon 510 may be displayed alone, or icon 512 may be displayed alone.

Coaching messages may be provided to transportation providers as a message displayed visually and/or as an audio message. Coaching messages may be displayed on a display of a transportation provider device as described above in detail with respect to FIGS. 3-5. Additionally or alternatively, the dynamic transportation system application may provide coaching to transportation providers as audio messages delivered through a dynamic transportation system application running on the transportation provider's device as the transportation service is being provided to transportation requesters. For example, the dynamic transportation system application may provide an audio message coaching the transportation provider to carry a transportation requester's luggage as the vehicle arrives at a pickup or drop-off location. In some examples, the audio messages coaching a transportation provider may be a pre-recorded audio message. The audio messages may be delivered to the transportation provider through an audio transducer (e.g., a speaker). The audio messages may be delivered through an audio transducer included in the transportation provider device and/or the audio messages may be transmitted to an audio transducer in the transportation provider vehicle. The audio message may be transmitted to the vehicle audio transducer over a cable and/or over a wireless connection (e.g., a Bluetooth wireless connection).

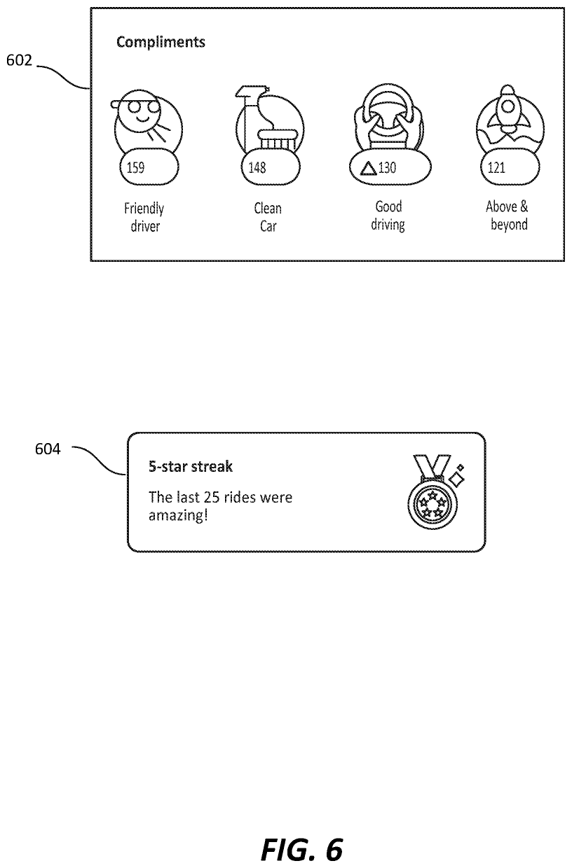

FIG. 6 illustrates an example device screen for providing compliment and milestone messages to a transportation provider. FIG. 6 illustrates a device screen for displaying compliments received from transportation requesters that have received transportation services from the transportation requester. Each of the compliments 602 may include a counter that indicates the number of compliments for each type of compliment. The counter may indicate the total number of compliments received or may indicate the number of compliments received with a time period or within a previous number of transportation services (e.g., previous twenty transportation services completed). The compliments may be ordered from left to right based on a descending number of compliments received. FIG. 6 also shows milestones 604 for displaying milestones reached by the transportation provider. For example, milestone 604 may display an icon indicating that a previous number (e.g., 25) of transportation services were completed with high ratings (e.g., rating of 5 out of 5). Milestone 604 may be displayed for a set time period (e.g., one day). In some examples, milestone 604 may only display for transportation providers that have ratings and/or account standing scores above a threshold level (e.g., good or excellent ratings, normal Account Standing Scores). In some examples, milestone 604 may only display for transportation providers that have no tips or performance improvements to display.

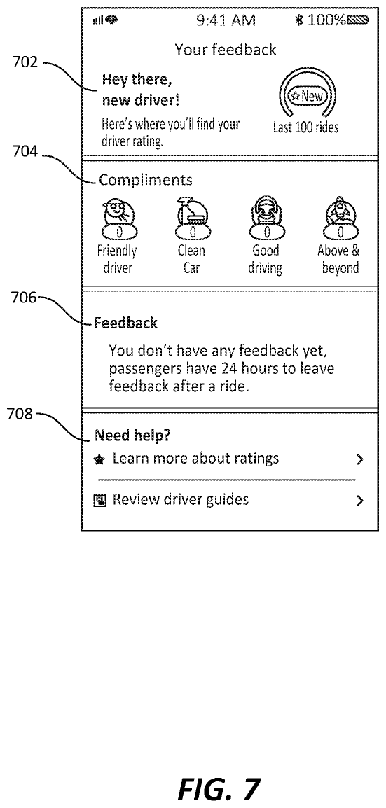

FIG. 7 illustrates an example device screen for providing consolidated feedback messages to a new transportation provider for which a limited amount of performance data has been collected. When a new transportation provider lacks feedback messages due to having performed a limited number of transportation services, the new transportation provider may receive educational content related to providing transportation services. The example illustrated in FIG. 7 shows a new transportation provider screen including section 702 that provides a welcome message and a rating icon indicating a new transportation provider. Compliment section 704 may show compliment icons with the number of compliments set at zero indicating the transportation provider has not yet received any compliments due to providing a limited number of transportation services. Feedback section 706 may show a message indicating the transportation provider has not yet received any feedback and informing the transportation provider that transportation requesters may leave feedback messages within 24 hours after completing a transportation service. Section 708 may include links the transportation provider may select to view content associated with ratings, transportation provider guides, and assistance with improving transportation provider performance. In some examples, new transportation providers may not receive any negative feedback messages until a threshold number (e.g., 20, SO) of negative feedback messages have been received. Additionally or alternatively, icon 510 and/or icon 512 of FIG. 5 may be displayed in any of the sections of the display screen of FIG. 7. Icon 510 may display a gauge icon and current rating number of the transportation provider. Icon 512 may display a hazard icon indicating the transportation provider is at risk of suspension or deactivation. In some examples, both icon 510 and icon 512 may be displayed, icon 510 may be displayed alone, or icon 512 may be displayed alone.

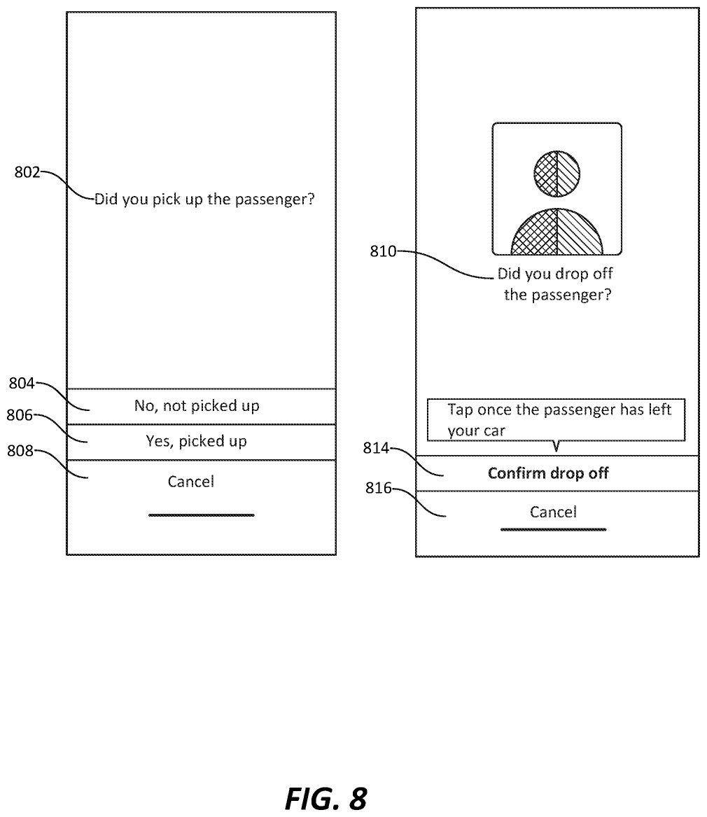

FIG. 8 illustrates an example device screen for confirming transportation services by a transportation provider. In some examples, a dynamic transportation system may calculate whether a distance traveled during a transportation service is below a threshold (e.g., a haversine distance less than 0.1 miles) in order to determine whether a transportation service has been inadvertently entered by the transportation provider. The dynamic transportation system may also calculate whether the time period for the transportation service is below a threshold (e.g., less than 10 minutes). In response to the distance traveled and/or a time period for the transportation service being below the threshold, feedback message 802 may be displayed that includes a query related to verification of a transportation requester pickup communication (e.g., “Did you pick up the passenger?”) or transportation requester drop-off communication 810 (e.g., “Did you drop off the passenger?”). The transportation provider may respond using the transportation provider's device using a tap or a swipe on the computing device. The dynamic transportation system may receive the response to the query from the transportation provider device that verifies or cancels the transportation requester pickup communication or the transportation requester drop-off communication. In response to the query related to picking up the transportation requester, the transportation provider may select response 804 indicating the transportation has not been picked up, the transportation provider may select response 806 indicating the transportation has been picked up, or the transportation provider may select response 808 indicating the cancellation of the pickup confirmation. In response to the query related to dropping off the transportation requester, the transportation provider may select response 814 confirming that the transportation has been dropped off or the transportation provider may select response 816 indicating the cancellation of the drop-off confirmation. The transportation provider may remediate an action such as inadvertently communicating a pickup or drop-off by canceling the confirmation. In some examples, the dynamic transportation system may reduce a transportation provider's rating in response to determining that a transportation provider has confirmed a transportation requester pickup and/or drop off when the transportation provider has not performed a transportation service.

FIG. 9 is a flow diagram of an example method for consolidating feedback to transportation providers in a transportation management system. As shown in FIG. 9, the method may include, at step 910, collecting performance data associated with a performance of a transportation provider within a dynamic transportation network. Examples of collecting performance data associated with the performance of the transportation provider within a dynamic transportation network may include the methods described in detail above with respect to FIG. 2. At step 920, the method may include displaying a status summary message on a transportation provider device that reflects the performance data. Examples of displaying a status summary message on the transportation provider device that reflects the performance data may include the methods described in detail above with respect to FIGS. 3 and 4. At step 930, the method may include displaying a notification message simultaneously with displaying the status summary message on the transportation provider device, the notification message coaching the transportation provider to improve a transportation service in light of the performance data. An example of displaying a notification message simultaneously with displaying the status summary message on the transportation provider device may include displaying the notification message and the status summary message at the same time on the same transportation provider device. Further examples of displaying a notification message simultaneously with displaying the status summary message on the transportation provider device to coach a transportation provider may include the methods described in detail above with respect to FIGS. 3-6.

In one example, a computer-implemented method for providing feedback messages to a transportation provider may include collecting performance data associated with a performance of a transportation provider within a dynamic transportation network. The method may further include monitoring contextual data that describes a context within which the transportation provider is providing a transportation service. The method may further include determining, based at least in part on the contextual data, that the performance data is relevant to the context, and providing a feedback message to a transportation provider device in response to determining that the performance data is relevant to the context, the feedback message coaching the transportation provider to improve the transportation service in light of the performance data.

In some examples, the performance data associated with the performance of the transportation provider may include data received from at least one of a transportation requester associated with the transportation service, sensor data from a vehicle of the transportation provider, and a data server.

In some examples, the contextual data associated with the performance of the transportation provider may include at least one of a type of transportation service, a pickup location of the transportation service, a drop-off location of the transportation service, a transportation service history of the transportation provider, and a preference of a transportation requester.

In some examples, the method may further include remediating, by the transportation provider, an action associated with the transportation service based on the content of the feedback message.

In some examples, the method may further include prioritizing a plurality of feedback messages and presenting the plurality of feedback messages to the transportation provider device in a consolidated view.

In some examples, the feedback message to the transportation provider device may include at least one of a rating associated with the transportation provider, a change in the rating associated with the transportation provider, a status indicator associated with the transportation provider, comments received from transportation requesters, conformance to transportation service requirements, and transportation provider milestones associated with providing the transportation service.

In some examples, the method may further include collecting comments from transportation requesters, anonymizing the comments collected from the transportation requesters, and providing the anonymized comments to the transportation provider device in a batch.

In some examples, collecting the performance data may comprise requesting performance data from a transportation requester.

In some examples, the method may further include selecting a flag based on a context of a recent transportation service provided by the transportation provider to the transportation requester and presenting the flag to the transportation requester on a transportation requester device to request performance data from the transportation requester, wherein the feedback message may include the performance data requested from the transportation requester.

In some examples, the method may further include determining whether a distance traveled during the transportation service is below a threshold and in response to the distance traveled being below the threshold, the feedback message may include a query related to verification of at least one of a transportation requester pickup communication or a transportation requester drop-off communication. The method may further include receiving, from the transportation provider device, a response to the query that verifies or cancels the transportation requester pickup communication or the transportation requester drop-off communication.

In some examples, the method may further include reducing a transportation provider rating in response to receiving, from the transportation provider device, the response to the query that verifies the transportation requester pickup communication or the transportation requester drop-off communication.

In some examples, the method may further include providing the notification message to the driver as an audio message from the driver device.

In addition, a corresponding system for providing feedback messages to a transportation provider may include one or more physical processors and one or more memories coupled to one or more of the physical processors, the one or more memories comprising instructions operable when executed by the one or more physical processors to cause the system to perform operations including collecting performance data associated with a performance of a transportation provider within a dynamic transportation network. The operations may further include monitoring contextual data that describes a context within which the transportation provider is providing a transportation service, determining, based at least in part on the contextual data, that the performance data is relevant to the context, and providing a feedback message to a transportation provider device in response to determining that the performance data is relevant to the context, the feedback message coaching the transportation provider to improve the transportation service in light of the performance data.

In some examples, the performance data associated with the performance of the transportation provider may include data received from at least one of a transportation requester associated with the transportation service, sensor data from a vehicle of the transportation provider, and a data server.

In some examples, the contextual data associated with the performance of the transportation provider may include at least one of a type of transportation service, a pickup location of the transportation service, a drop-off location of the transportation service, a transportation service history of the transportation provider, and a preference of a transportation requester.

In some examples, the operations may further include remediating, by the transportation provider, an action associated with the transportation service based on the content of the feedback message.

In some examples, the operations may further include prioritizing a plurality of feedback messages, and presenting the plurality of feedback messages to the transportation provider device in a consolidated view.

In some examples, the feedback message to the transportation provider device may include at least one of a rating associated with the transportation provider, a change in the rating associated with the transportation provider, a status indicator associated with the transportation provider, comments received from transportation requesters, conformance to transportation service requirements, and transportation provider milestones associated with providing the transportation service.

In some examples, the operations may further include collecting comments from transportation requesters, anonymizing the comments collected from the transportation requesters, and providing the anonymized comments to the transportation provider device in a batch.

In some examples, collecting the performance data may include requesting performance data from a transportation requester.

In some examples, the above-described method may be encoded as computer-readable instructions on a computer-readable medium. For example, a computer-readable medium may include one or more computer-executable instructions that, when executed by at least one processor of a computing device, may cause the computing device to collect performance data associated with a performance of a transportation provider within a dynamic transportation network, monitor contextual data that describes a context within which the transportation provider is providing a transportation service, determine, based at least in part on the contextual data, that the performance data is relevant to the context, and provide a feedback message to a transportation provider device in response to determining that the performance data is relevant to the context, the feedback message coaching the transportation provider to improve the transportation service in light of the performance data.

Embodiments of the instant disclosure may include or be implemented in conjunction with a transportation management system. A transportation management system may arrange rides on an on-demand and/or ad-hoc basis by, e.g., matching one or more ride requesters with one or more ride providers. For example, a transportation management system may provide one or more transportation matching services for a ridesharing service, a ridesourcing service, a taxicab service, a car-booking service, an autonomous vehicle service, or some combination and/or derivative thereof. The transportation management system may include and/or interface with any of a variety of subsystems that may implement, support, and/or improve a transportation matching service. For example, the transportation management system may include a matching system (e.g., that matches requesters to ride opportunities and/or that arranges for requesters and/or providers to meet), a mapping system, a navigation system (e.g., to help a provider reach a requester, to help a requester reach a provider, and/or to help a provider reach a destination), a reputation system (e.g., to rate and/or gauge the trustworthiness of a requester and/or a provider), a payment system, and/or an autonomous or semi-autonomous driving system. The transportation management system may be implemented on various platforms, including a requester-owned mobile device, a computing system installed in a vehicle, a requester-owned mobile device, a server computer system, or any other hardware platform capable of providing transportation matching services to one or more requesters and/or providers.

FIG. 10 shows a transportation management environment 1000, in accordance with various embodiments. As shown in FIG. 10, a transportation management system 1002 may run one or more services and/or software applications, including identity management services 1004, location services 1006, ride services 1008, and/or other services. Although FIG. 10 shows a certain number of services provided by transportation management system 1002, more or fewer services may be provided in various implementations. In addition, although FIG. 10 shows these services as being provided by transportation management system 1002, all or a portion of any of the services may be processed in a distributed fashion. For example, computations associated with a service task may be performed by a combination of transportation management system 1002 (including any number of servers, databases, etc.), one or more devices associated with a provider (e.g., devices integrated with managed vehicles 1014, provider's computing devices 1016 and tablets 1020, and transportation management vehicle devices 1018), and/or more or more devices associated with a ride requester (e.g., the requester's computing devices 1024 and tablets 1022). In some embodiments, transportation management system 1002 may include one or more general purpose computers, server computers, clustered computing systems, cloud-based computing systems, and/or any other computing systems or arrangements of computing systems. Transportation management system 1002 may be configured to run any or all of the services and/or software components described herein. In some embodiments, the transportation management system 1002 may include an appropriate operating system and/or various server applications, such as web servers capable of handling hypertext transport protocol (HTTP) requests, file transfer protocol (FTP) servers, database servers, etc.

In some embodiments, identity management services 1004 may be configured to perform authorization services for requesters and providers and/or manage their interactions and/or data with transportation management system 1002. This may include, e.g., authenticating the identity of providers and determining that they are authorized to provide services through transportation management system 1002. Similarly, requesters' identities may be authenticated to determine whether they are authorized to receive the requested services through transportation management system 1002. Identity management services 1004 may also manage and/or control access to provider and/or requester data maintained by transportation management system 1002, such as driving and/or ride histories, vehicle data, personal data, preferences, usage patterns as a ride provider and/or as a ride requester, profile pictures, linked third-party accounts (e.g., credentials for music and/or entertainment services, social-networking systems, calendar systems, task-management systems, etc.) and any other associated information. Transportation management system 1002 may also manage and/or control access to provider and/or requester data stored with and/or obtained from third-party systems. For example, a requester or provider may grant access to a third-party email, calendar, or task management system (e.g., via the user's credentials). As another example, a requester or provider may grant, through a mobile device (e.g., 1016, 1020, 1022, or 1024), a transportation application associated with transportation management system 1002 access to data provided by other applications installed on the mobile device. In some examples, such data may be processed on the client and/or uploaded to transportation management system 1002 for processing.

In some embodiments, transportation management system 1002 may provide ride services 1008, which may include ride matching and/or management services to connect a requester to a provider. For example, after identity management services module 1004 has authenticated the identity a ride requester, ride services module 1008 may attempt to match the requester with one or more ride providers. In some embodiments, ride services module 1008 may identify an appropriate provider using location data obtained from location services module 1006. Ride services module 1008 may use the location data to identify providers who are geographically close to the requester (e.g., within a certain threshold distance or travel time) and/or who are otherwise a good match with the requester. Ride services module 1008 may implement matching algorithms that score providers based on, e.g., preferences of providers and requesters; vehicle features, amenities, condition, and/or status; providers' preferred general travel direction and/or route, range of travel, and/or availability; requesters' origination and destination locations, time constraints, and/or vehicle feature needs; and any other pertinent information for matching requesters with providers. In some embodiments, ride services module 1008 may use rule-based algorithms and/or machine-learning models for matching requesters and providers.

Transportation management system 1002 may communicatively connect to various devices through networks 1010 and/or 1012. Networks 1010 and 1012 may include any combination of interconnected networks configured to send and/or receive data communications using various communication protocols and transmission technologies. In some embodiments, networks 1010 and/or 1012 may include local region networks (LANs), wide-region networks (WANs), and/or the Internet, and may support communication protocols such as transmission control protocol/Internet protocol (TCP/IP), Internet packet exchange (IPX), systems network architecture (SNA), and/or any other suitable network protocols. In some embodiments, data may be transmitted through networks 1010 and/or 1012 using a mobile network (such as a mobile telephone network, cellular network, satellite network, or other mobile network), a public switched telephone network (PSTN), wired communication protocols (e.g., Universal Serial Bus (USB), Controller Region Network (CAN)), and/or wireless communication protocols (e.g., wireless LAN (WLAN) technologies implementing the IEEE 802.11 family of standards, Bluetooth, Bluetooth Low Energy, Near Field Communication (NFC), Z-Wave, and ZigBee). In various embodiments, networks 1010 and/or 1012 may include any combination of networks described herein or any other type of network capable of facilitating communication across networks 1010 and/or 1012.

In some embodiments, transportation management vehicle device 1018 may include a provider communication device configured to communicate with users, such as drivers, passengers, pedestrians, and/or other users. In some embodiments, transportation management vehicle device 1018 may communicate directly with transportation management system 1002 or through another provider computing device, such as provider computing device 1016. In some embodiments, a requester computing device (e.g., device 1024) may communicate via a connection 1026 directly with transportation management vehicle device 1018 via a communication channel and/or connection, such as a peer-to-peer connection, Bluetooth connection, NFC connection, ad hoc wireless network, and/or any other communication channel or connection. Although FIG. 10 shows particular devices communicating with transportation management system 1002 over networks 1010 and 1012, in various embodiments, transportation management system 1002 may expose an interface, such as an application programming interface (API) or service provider interface (SPI) to enable various third parties which may serve as an intermediary between end users and transportation management system 1002.

In some embodiments, devices within a vehicle may be interconnected. For example, any combination of the following may be communicatively connected: vehicle 1014, provider computing device 1016, provider tablet 1020, transportation management vehicle device 1018, requester computing device 1024, requester tablet 1022, and any other device (e.g., smart watch, smart tags, etc.). For example, transportation management vehicle device 1018 may be communicatively connected to provider computing device 1016 and/or requester computing device 1024. Transportation management vehicle device 1018 may establish communicative connections, such as connections 1026 and 1028, to those devices via any suitable communication technology, including, e.g., WLAN technologies implementing the IEEE 802.11 family of standards, Bluetooth, Bluetooth Low Energy, NFC, Z-Wave, ZigBee, and any other suitable short-range wireless communication technology.

In some embodiments, users may utilize and interface with one or more services provided by the transportation management system 1002 using applications executing on their respective computing devices (e.g., 1016, 1018, 1020, and/or a computing device integrated within vehicle 1014), which may include mobile devices (e.g., an iPhone®, an iPad®, mobile telephone, tablet computer, a personal digital assistant (PDA)), laptops, wearable devices (e.g., smart watch, smart glasses, head mounted displays, etc.), thin client devices, gaming consoles, and any other computing devices. In some embodiments, vehicle 1014 may include a vehicle-integrated computing device, such as a vehicle navigation system, or other computing device integrated with the vehicle itself, such as the management system of an autonomous vehicle. The computing device may run on any suitable operating systems, such as Android®, iOS®, macOS®, Windows®, Linux®, UNIX®, or UNIX®-based or Linux®-based operating systems, or other operating systems. The computing device may further be configured to send and receive data over the Internet, short message service (SMS), email, and various other messaging applications and/or communication protocols. In some embodiments, one or more software applications may be installed on the computing device of a provider or requester, including an application associated with transportation management system 1002. The transportation application may, for example, be distributed by an entity associated with the transportation management system via any distribution channel, such as an online source from which applications may be downloaded. Additional third-party applications unassociated with the transportation management system may also be installed on the computing device. In some embodiments, the transportation application may communicate or share data and resources with one or more of the installed third-party applications.

FIG. 11 shows a data collection and application management environment 1100, in accordance with various embodiments. As shown in FIG. 11, management system 1102 may be configured to collect data from various data collection devices 1104 through a data collection interface 1106. As discussed above, management system 1102 may include one or more computers and/or servers or any combination thereof. Data collection devices 1104 may include, but are not limited to, user devices (including provider and requester computing devices, such as those discussed above), provider communication devices, laptop or desktop computers, vehicle data (e.g., from sensors integrated into or otherwise connected to vehicles), ground-based or satellite-based sources (e.g., location data, traffic data, weather data, etc.), or other sensor data (e.g., roadway embedded sensors, traffic sensors, etc.). Data collection interface 1106 can include, e.g., an extensible device framework configured to support interfaces for each data collection device. In various embodiments, data collection interface 1106 may be extended to support new data collection devices as they are released and/or to update existing interfaces to support changes to existing data collection devices. In various embodiments, data collection devices may communicate with data collection interface 1106 over one or more networks. The networks may include any network or communication protocol as would be recognized by one of ordinary skill in the art, including those networks discussed above.

As shown in FIG. 11, data received from data collection devices 1104 can be stored in data store 1108. Data store 1108 may include one or more data stores, such as databases, object storage systems and services, cloud-based storage services, and other data stores. For example, various data stores may be implemented on a non-transitory storage medium accessible to management system 1102, such as historical data store 1110, ride data store 1112, and user data store 1114. Data stores 1108 can be local to management system 1102, or remote and accessible over a network, such as those networks discussed above or a storage-region network or other networked storage system. In various embodiments, historical data 1110 may include historical traffic data, weather data, request data, road condition data, or any other data for a given region or regions received from various data collection devices. Ride data 1112 may include route data, request data, timing data, and other ride related data, in aggregate and/or by requester or provider. User data 1114 may include user account data, preferences, location history, and other user-specific data. Although certain data stores are shown by way of example, any data collected and/or stored according to the various embodiments described herein may be stored in data stores 1108.

As shown in FIG. 11, an application interface 1116 can be provided by management system 1102 to enable various apps 1118 to access data and/or services available through management system 1102. Apps 1118 may run on various user devices (including provider and requester computing devices, such as those discussed above) and/or may include cloud-based or other distributed apps configured to run across various devices (e.g., computers, servers, or combinations thereof). Apps 1118 may include, e.g., aggregation and/or reporting apps which may utilize data 1108 to provide various services (e.g., third-party ride request and management apps). In various embodiments, application interface 1116 can include an API and/or SPI enabling third party development of apps 1118. In some embodiments, application interface 1116 may include a web interface, enabling web-based access to data 1108 and/or services provided by management system 1102. In various embodiments, apps 1118 may run on devices configured to communicate with application interface 1116 over one or more networks. The networks may include any network or communication protocol as would be recognized by one of ordinary skill in the art, including those networks discussed above, in accordance with an embodiment of the present disclosure.

While various embodiments of the present disclosure are described in terms of a ridesharing service in which the ride providers are human drivers operating their own vehicles, in other embodiments, the techniques described herein may also be used in environments in which ride requests are fulfilled using autonomous vehicles. For example, a transportation management system of a ridesharing service may facilitate the fulfillment of ride requests using both human drivers and autonomous vehicles.

As detailed above, the computing devices and systems described and/or illustrated herein broadly represent any type or form of computing device or system capable of executing computer-readable instructions, such as those contained within the modules described herein. In their most basic configuration, these computing device(s) may each include at least one memory device and at least one physical processor.

In some examples, the term “memory device” generally refers to any type or form of volatile or non-volatile storage device or medium capable of storing data and/or computer-readable instructions. In one example, a memory device may store, load, and/or maintain one or more of the modules described herein. Examples of memory devices include, without limitation, Random Access Memory (RAM), Read Only Memory (ROM), flash memory, Hard Disk Drives (HDDs), Solid-State Drives (SSDs), optical disk drives, caches, variations or combinations of one or more of the same, or any other suitable storage memory.

In some examples, the term “physical processor” generally refers to any type or form of hardware-implemented processing unit capable of interpreting and/or executing computer-readable instructions. In one example, a physical processor may access and/or modify one or more modules stored in the above-described memory device. Examples of physical processors include, without limitation, microprocessors, microcontrollers, Central Processing Units (CPUs), Field-Programmable Gate Arrays (FPGAs) that implement softcore processors, Application-Specific Integrated Circuits (ASICs), portions of one or more of the same, variations or combinations of one or more of the same, or any other suitable physical processor.

Although illustrated as separate elements, the modules described and/or illustrated herein may represent portions of a single module or application. In addition, in certain embodiments one or more of these modules may represent one or more software applications or programs that, when executed by a computing device, may cause the computing device to perform one or more tasks. For example, one or more of the modules described and/or illustrated herein may represent modules stored and configured to run on one or more of the computing devices or systems described and/or illustrated herein. One or more of these modules may also represent all or portions of one or more special-purpose computers configured to perform one or more tasks.

In addition, one or more of the modules described herein may transform data, physical devices, and/or representations of physical devices from one form to another. Additionally or alternatively, one or more of the modules recited herein may transform a processor, volatile memory, non-volatile memory, and/or any other portion of a physical computing device from one form to another by executing on the computing device, storing data on the computing device, and/or otherwise interacting with the computing device.

In some embodiments, the term “computer-readable medium” generally refers to any form of device, carrier, or medium capable of storing or carrying computer-readable instructions. Examples of computer-readable media include, without limitation, transmission-type media, such as carrier waves, and non-transitory-type media, such as magnetic-storage media (e.g., hard disk drives, tape drives, and floppy disks), optical-storage media (e.g., Compact Disks (CDs), Digital Video Disks (DVDs), and BLU-RAY disks), electronic-storage media (e.g., solid-state drives and flash media), and other distribution systems.

The process parameters and sequence of the steps described and/or illustrated herein are given by way of example only and can be varied as desired. For example, while the steps illustrated and/or described herein may be shown or discussed in a particular order, these steps do not necessarily need to be performed in the order illustrated or discussed. The various exemplary methods described and/or illustrated herein may also omit one or more of the steps described or illustrated herein or include additional steps in addition to those disclosed.

The preceding description has been provided to enable others skilled in the art to best utilize various aspects of the exemplary embodiments disclosed herein. This exemplary description is not intended to be exhaustive or to be limited to any precise form disclosed. Many modifications and variations are possible without departing from the spirit and scope of the instant disclosure. The embodiments disclosed herein should be considered in all respects illustrative and not restrictive. Reference should be made to the appended claims and their equivalents in determining the scope of the instant disclosure.

Unless otherwise noted, the terms “connected to” and “coupled to” (and their derivatives), as used in the specification and claims, are to be construed as permitting both direct and indirect (i.e., via other elements or components) connection. In addition, the terms “a” or “an,” as used in the specification and claims, are to be construed as meaning “at least one of.” Finally, for ease of use, the terms “including” and “having” (and their derivatives), as used in the specification and claims, are interchangeable with and have the same meaning as the word “comprising.”

What is claimed is:

1. A computer-implemented method comprising:
collecting, by one or more server devices, performance data associated with a performance of a provider computing device within a dynamic transportation network;
generating, utilizing the one or more server devices, a provider computing device rating based on the performance data;
monitoring, via the one or more server devices from the provider computing device or a requester computing device, contextual data indicating a context of a digital service request received from the requester computing device;
providing, for display within a user interface of the provider computing device, a status message based on the provider computing device rating; and
based on determining a measure of relevance between the contextual data and the performance data, providing, for display within the user interface of the provider computing device simultaneously with the status message, a notification message comprising a modification directive corresponding to the performance data.

2. The computer-implemented method of claim 1, further comprising:
providing, for display via user interfaces of requester computing devices matched to the provider computing device, a plurality of digital compliment elements;
monitoring, via the one or more server devices, interactions with digital compliment elements at the requester computing devices matched to the provider computing device; and
providing, for display on the user interface of the provider computing device simultaneously with the status message and the notification message, a digital compliments counter element based on the interactions with the digital compliment elements at the requester computing devices matched to the provider computing device.

3. The computer-implemented method of claim 1, wherein collecting the performance data associated with the performance of the provider computing device includes collecting data from at least one of a requester computing device associated with the digital service request, sensor data from a vehicle of the provider computing device, or a data server.

4. The computer-implemented method of claim 1, wherein monitoring the contextual data includes monitoring at least one of a type of digital service request, a pickup location of the digital service request, a drop-off location of the digital service request, a digital service request history of the provider computing device, or a preference of the requester computing device.

5. The computer-implemented method of claim 1, wherein providing the status message further comprises:
determining a provider tier based on the provider computing device rating;
providing, for display within the user interface of the provider computing device, a summary text corresponding to the provider tier; and
providing the provider computing device rating for display within the user interface of the provider computing device simultaneously with the summary text, the status message, and the notification message.

6. The computer-implemented method of claim 1, further comprising:
prioritizing a plurality of notification messages; and
displaying the plurality of notification messages in the user interface of the provider computing device in a consolidated view.

7. The computer-implemented method of claim 1, further comprising monitoring, via the one or more server devices, interactions with requester computing devices matched to the provider computing device to determine instances of feedback.

8. The computer-implemented method of claim 7, further comprising providing, for display within the user interface of the provider computing device simultaneously with the status message and the notification message, a feedback feed comprising the instances of feedback from the requester computing devices matched to the provider computing device.

9. The computer-implemented method of claim 1, further comprising collecting the performance data by:
providing, for display via a user interface of the requester computing device, one or more selectable binary interactive elements; and
receiving a selection of a selectable binary interactive element of the one or more selectable binary interactive elements.

10. The computer-implemented method of claim 9, further comprising:
based on receiving the selection of the selectable binary interactive element, generating a feedback message; and
providing, for display on a user interface of the provider computing device, the feedback message simultaneously with the status message and the notification message.

11. A system comprising:
at least one processor; and
a non-transitory computer readable storage medium comprising instructions that, when executed by the at least one processor, cause the system to:
collect, by one or more server devices, performance data associated with a performance of a provider computing device within a dynamic transportation network;
generate, utilizing the one or more server devices, a provider computing device rating based on the performance data;
monitor, via the one or more server devices from the provider computing device or a requester computing device, contextual data indicating a context of a digital service request received from the requester computing device;
provide, for display within a user interface of the provider computing device, a status message based on the provider computing device rating; and
based on determining a measure of relevance between the contextual data and the performance data, provide, for display within the user interface of the provider computing device simultaneously with the status message, a notification message comprising a modification directive corresponding to the performance data.

12. The system of claim 11, further comprising instructions that, when executed by the at least one processor, cause the system to:
provide, for display via user interfaces of requester computing devices matched to the provider computing device, a plurality of digital compliment elements;
monitor, via the one or more server devices, interactions with digital compliment elements at the requester computing devices matched to the provider computing device; and
provide, for display on the user interface of the provider computing device simultaneously with the status message and the notification message, a digital compliments counter element based on the interactions with the digital compliment elements at the requester computing devices matched to the provider computing device.

13. The system of claim 11, further comprising instructions that, when executed by the at least one processor, cause the system to collect the performance data associated with the performance of the provider computing device by collecting data from at least one of a requester computing device associated with the digital service request, sensor data from a vehicle of the provider computing device, or a data server.

14. The system of claim 11, further comprising instructions that, when executed by the at least one processor, cause the system to monitor the contextual data by monitoring at least one of a type of digital service request, a pickup location of the digital service request, a drop-off location of the digital service request, a digital service request history of the provider computing device, or a preference of the requester computing device.

15. The system of claim 11, further comprising instructions that, when executed by the at least one processor, cause the system to provide the status message by:
determining a provider tier based on the provider computing device rating;
providing, for display within the user interface of the provider computing device, a summary text corresponding to the provider tier; and
providing the provider computing device rating for display within the user interface of the provider computing device simultaneously with the summary text, the status message, and the notification message.

16. A non-transitory computer readable storage medium comprising instructions that, when executed by at least one processor, cause the at least one processor to:
collect, by one or more server devices, performance data associated with a performance of a provider computing device within a dynamic transportation network;
generate, utilizing the one or more server devices, a provider computing device rating based on the performance data;
monitor, via the one or more server devices from the provider computing device or a requester computing device, contextual data indicating a context of a digital service request for a digital service request received from the requester computing device;
provide, for display within a user interface of the provider computing device, a status message based on the provider computing device rating; and
based on determining a measure of relevance between the contextual data and the performance data, provide, for display within the user interface of the provider computing device simultaneously with the status message, a notification message comprising a modification directive corresponding to the performance data.

17. The non-transitory computer readable storage medium of claim 16, further comprising instructions that, when executed by the at least one processor, cause the at least one processor to:
prioritize a plurality of notification messages; and
display the plurality of notification messages in the user interface of the provider computing device in a consolidated view.

18. The non-transitory computer readable storage medium of claim 16, further comprising instructions that, when executed by the at least one processor, cause the at least one processor to:
monitor, via the one or more server devices, interactions with requester devices matched to the provider computing device to determine instances of feedback; and
provide, for display within the user interface of the provider computing device simultaneously with the status message and the notification message, a feedback feed comprising the instances of feedback from the requester devices matched to the provider computing device.

19. The non-transitory computer readable storage medium of claim 16, further comprising instructions that, when executed by the at least one processor, cause the at least one processor to:
provide, for display via a user interface of the requester computing device, one or more selectable binary interactive elements; and
receive a selection of a selectable binary interactive element of the one or more selectable binary interactive elements.

20. The non-transitory computer readable storage medium of claim 19, further comprising instructions that, when executed by the at least one processor, cause the at least one processor to:
generate, based on receiving the selection of the selectable binary interactive element, a feedback message; and
provide, for display on a user interface of the provider computing device, the feedback message simultaneously with the status message and the notification message.
